(19) United States
(12) Patent Application Publication
(10) Pub. No.: US 2007/0182960 A1
(43) Pub. Date: Aug. 9, 2007

(54) Compact laser spectrometer

(76) Inventor: Vijaysekhar Jayaraman, Goleta, CA (US)

Correspondence Address: Vijaysekhar Jayaraman, Praevium Research Inc., 270 Coronado Drive, Goleta, CA, 93117, US

(21) Appl. No.: 11/654,772

(22) Filed: Jan. 18, 2007

Related U.S. Application Data
(60) Provisional application No. 60/760,619, filed on Jan. 20, 2006.

(51) Int. Cl. G01J 3/00; G01J 3/30

(52) U.S. Cl. 356/318; 356/300

(57) ABSTRACT

A compact laser spectrometer according to the present invention includes a plurality of semiconductor lasers comprising a plurality of semiconductor gain medium compositions emitting a plurality of radiation components originating from an area having a maximum transverse dimension that is smaller than a minimum feature size of a sample. A broadband optical detector detects a diffuse reflectance. In one preferred embodiment of this invention the plurality of semiconductor lasers consists of Fabry-Perot edge-emitting lasers arranged around the perimeter of a cylindrical submount with a substantially circular cross-section. The plurality of radiation components is directly coupled to a multi-mode optical fiber, which presents radiation to a sample. In another preferred embodiment a linear array of Fabry-Perot edge-emitting lasers is directly coupled to a multi-mode fiber. In still another preferred embodiment, a two-dimensional array of vertical cavity surface-emitting lasers is directly coupled to a multi-mode optical fiber.

### CROSS-REFERENCES TO RELATED APPLICATIONS

This application is entitled to the benefit of Provisional Patent Application Ser. No. 60/760,619, filed 2006, Jan. 20.

### STATEMENT REGARDING FEDERALLY SPONSORED RESEARCH OR DEVELOPMENT

This invention was made under a government grant. The U.S. government may have rights in this invention.

### BACKGROUND

1. Field of the Invention

This invention relates generally to tunable sources, spectroscopy, and multi-wavelength laser arrays.

2. Description of Prior Art

Spectroscopy refers to the use of multi-wavelength radiation to non-invasively probe a variety of samples to determine the composition, health, or function of those samples. Prior-art spectroscopy is done with filtered white light sources, as illustrated in the prior art FIG. 1. Here, a white light source 100 emits a broadband radiation 130, which is filtered with a tunable monochromator 110, comprising a rotating grating 114 and slit 118, to generate a narrowband radiation 150, which probes a sample 120. A diffuse reflected radiation 160 is then detected by an optical detector 140. By tuning the monochromator 110, it is possible to construct a spectrum of the reflected radiation 160, which provides non-invasive information about the sample 120.

Although it enables spectral measurements over a wide wavelength coverage, the prior-art white light spectrometer of FIG. 1 suffers from a number of limitations. First, the filtered white light source has weak signal to noise ratio. Second, the grating-based system has critical intra-system mechanical alignments, and contains moving parts, leading to a bulky and complex system with slow measurement times. Lastly, some applications, such as (B. Tromberg, N. Shah, R. Lanning, A. Cerussi, J. Espinoza, T. Pham, L. Svaasand, and J. Butler, “Non-Invasive In Vivo Characterization of Breast Tumors Using Photon Migration Spectroscopy,” Neoplasia, vol. 2, nos. 1-2, January-April 2000, pp. 26-40) employ frequency domain measurements, which are not presently possible with white light sources, since white light sources cannot be easily modulated at the required 100 Megahertz (Mhz) to 3 Gigahertz (Ghz) rates.

One solution to these problems is to replace the white-light source with a tunable semiconductor laser. This eliminates the grating, since the laser provides a source of tunable narrow-band radiation which requires no further filtering. Semiconductor lasers are also capable of being modulated at multi-Ghz rates. However, prior art tunable semiconductor lasers, such as those described in (B. Mason, S. Lee, M. E. Heimbuch, and L. A. Coldren, “Directly Modulated Sampled Grating DBR Lasers for Long-Haul WDM Communication Systems,” IEEE Photonics Technology Letters, vol. 9, no. 5, March 1997, pp. 377-379), are limited in tuning range to less than 100 nanometers (nm), because of the fundamental gain-bandwidth limit of semiconductors. Most spectroscopic applications, such as near infrared spectroscopy from 1100-2500 nm, agricultural spectroscopy from 700-1700 nm, and tissue spectroscopy from 650-1000 nm, require several hundred nm bandwidth. Additionally, telecommunication lasers like the one in Mason, et al above employ complex and expensive means to enable all wavelengths to operate in a single spatial and spectral mode, which is unnecessary for many spectroscopic applications.

Many diffuse spectroscopy systems, though they require wide wavelength tuning range, can employ sources with relaxed spatial and spectral requirements relative to telecommunication lasers. One example of such a spectroscopy application is found in (B. Tromberg, N. Shah, R. Lanning, A. Cerussi, J. Espinoza, T. Pham, L. Svaasand, and J. Butler, “Non-Invasive In Vivo Characterization of Breast Tumors Using Photon Migration Spectroscopy,” Neoplasia, vol. 2, nos. 1-2, January-April 2000, pp. 26-40). This work employs multiple spatially separated sources, which is allowable as long as the source spatial extent is small compared to a minimum feature size of the sample being characterized. For example, typical breast tumors are more than 5 mm large, so a tunable source for characterizing breast tissue can be constructed with spatially separated sources over a spatial extent small compared to 5 mm. Additionally, multi-mode lasers with spectral bandwidth of 1-3 nm provide sufficient spectral resolution to probe all the necessary spectral features of breast tissue.

Prior researchers have used multiple discrete semiconductor lasers coupled to multiple optical fibers to assemble a tunable source with a spatial extent smaller than 5 mm, as in (B. Tromberg, N. Shah, R. Lanning, A. Cerussi, J. Espinoza, T. Pham, L. Svaasand, and J. Butler, “Non-Invasive In Vivo Characterization of Breast Tumors Using Photon Migration Spectroscopy,” Neoplasia, vol. 2, nos. 1-2, January-April 2000, pp. 26-40). This approach leads to a bulky and complex system, involving complex optical coupling components, multiple individually packaged devices, and limited scalability to a large number of wavelengths and multiple source positions around a sample.

From the foregoing, it is clear that what is required is a laser-based spectrometer that can employ semiconductor lasers in a compact configuration without semiconductor gain-bandwidth limitations, having a tuning range and spectral and spatial qualities appropriate for many spectroscopic applications, and capable of scalability to a large number of wavelengths.

### SUMMARY OF THE INVENTION

The present invention provides a plurality of semiconductor lasers comprising a plurality of semiconductor gain medium compositions clustered over a spatial extent that is small compared to a minimum feature size of a sample being probed. These semiconductor lasers can be arranged in a linear array or two-dimensional array. An output radiation of the semiconductor laser cluster is preferably directly coupled to an optical fiber and then presented to the sample, but can also be directly coupled to the sample with no intervening optics. An optical detector detects a diffuse reflectance or transmittance. All of these components combine to create a compact laser-based spectrometer with fast measurement time, high speed modulation, wide wavelength range, and high signal to noise ratio.

In one preferred embodiment of this invention, the semiconductor lasers are Fabry-Perot edge-emitting lasers which provide high output power, wavelength flexibility, and efficient thermal tuning. The Fabry-Perot lasers are arranged around the perimeter of a nearly circular cross-section cylindrical sub-carrier, enabling efficient coupling to a multi-mode optical fiber. In another preferred embodiment, the semiconductor lasers are vertical cavity lasers arranged in a 2-dimensional array.

A further understanding of the nature and advantages of the present invention may be realized by reference to the remaining portions of the specifications and drawings.

### BRIEF DESCRIPTION OF THE DRAWINGS

FIG. 1 is a schematic representation of a prior art grating-based spectrometer.

FIG. 2 is a schematic representation of an end view of a preferred embodiment of the present invention.

FIG. 3 is a schematic representation of a cross-section A-A′ through a portion of FIG. 2.

FIG. 4 is a schematic representation of an experimental configuration used to test a linear 4-channel array coupled to a single large-core multi-mode fiber according to the present invention.

FIG. 5 is a spectrum of wavelength bands emitted by the 4-channel array of FIG. 4.

FIG. 6 is a schematic representation of a preferred embodiment of the present invention employing vertical cavity surface emitting lasers.

### REFERENCE NUMERALS IN DRAWINGS

100 White light source

110 Tunable monochromator

120 Sample in prior art spectrometer

130 Broadband radiation emitted by white light source

140 Optical detector in prior art spectrometer

150 Narrow band radiation in prior art spectrometer

160 Diffuse reflectance from sample in prior art spectrometer

200 Edge-emitting lasers in spectrometer according to present invention

210 Multi-mode fiber core in spectrometer according present invention

220 Cylindrical sub-carrier in spectrometer according to present invention

225 Maximum transverse dimension of area from which plurality of radiation components emerge in spectrometer according to present invention.

250 Flex circuit in spectrometer according to present invention

260 Circuit board in spectrometer according to present invention

270 Radiation components from edge-emitting lasers in spectrometer according to present invention

280 Electrical connections in spectrometer according to present invention

290 Optical axis of cylindrical sub-carrier in spectrometer according to present invention

300 Radiation output from fiber core in spectrometer according to present invention

310 Sample in spectrometer according to present invention

315 Minimum feature size of sample in spectrometer according to present invention.

320 Diffuse reflectance from sample in spectrometer according to present invention

330 Optical detector in spectrometer according to present invention

400 4-channel linear array according to present invention

410 positive probe

420 negative probe

430 Temperature-controlled stage

440 Plurality of radiation components from 4-channel linear array

450 1 mm core diameter fiber used to test 4-channel linear array

500 First wavelength band

510 Second wavelength band

520 Third wavelength band

530 Fourth wavelength band

600 Multi-mode fiber core in VCSEL-based spectrometer according to present invention

610 Plurality of radiation components emitted by VCSELs in spectrometer according to present invention

620 Plurality of VCSELs in spectrometer according to present invention

### DETAILED DESCRIPTION OF PREFERRED AND ALTERNATE EMBODIMENTS

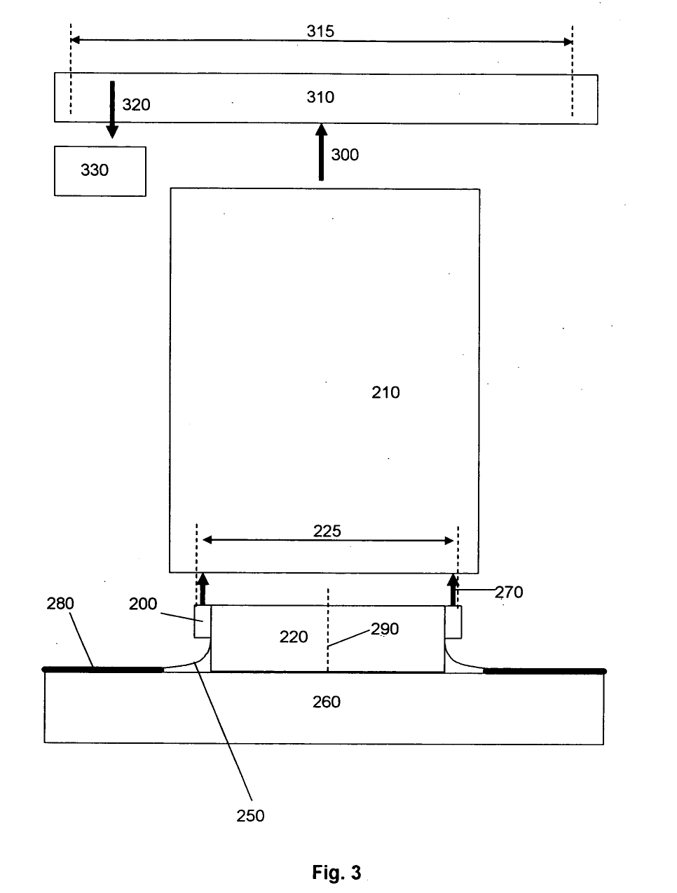

FIGS. 2 and 3 represent two views of a preferred embodiment of the present invention. FIG. 2 is an end view of a preferred embodiment of the present invention. The view of FIG. 2 is looking from the inside of a multi-mode optical fiber core 210 at a plurality of edge-emitting semiconductor lasers 200 arranged around the perimeter of a common circular cross-section cylindrical sub-carrier 220, fitting within the core of the multi-mode optical fiber 210. A plurality of radiation components 270 originates from an area having a maximum transverse dimension 225. Throughout this specification, whenever we refer to light “originating from” a location, we refer to the location at which the light first exits semiconductor, typically the output facet of a semiconductor laser diode. The configuration of FIG. 2 is in contrast to the configuration of (B. Tromberg, N. Shah, R. Lanning, A. Cerussi, J. Espinoza, T. Pham, L. Svaasand, and J. Butler, “Non-Invasive In Vivo Characterization of Breast Tumors Using Photon Migration Spectroscopy,” Neoplasia, vol. 2, nos. 1-2, January-April 2000, pp. 26-40), where radiation components from separately packaged laser diodes originate from an area large compared to a minimum feature size in breast tissue, and must be coupled to separate optical fibers which are subsequently bundled to reduce source spatial extent.

FIG. 2 illustrates, by way of example, 14 semiconductor lasers 200 and 14 radiation components 270. Although the optical fiber with core 210 is preferred, other embodiments of this invention could employ alternate light-guiding structures, such as waveguides, or a rigid glass rod functioning as a light-pipe. In yet another embodiment, the optical fiber could be eliminated entirely, and the plurality of radiation components 270 could impinge directly on a sample. Each of the plurality of lasers 200 employs a unique semiconductor gain medium composition with a unique gain peak wavelength. For example, the gain media could be quantum well regions with various compositions of InGaAsP or AlInGaAs, having gain peak wavelengths in the 1200-2100 nm range. The gain regions can be composed of any semiconductor known to provide optical gain for laser radiation. The use of a plurality of gain medium compositions overcomes the gain-bandwidth limitations of a single semiconductor gain medium, and enables the wide wavelength coverage required for spectroscopic applications. The plurality of semiconductor lasers 200 emits the plurality of radiation components 270 having a plurality of wavelengths into the fiber core 210 directly with no intervening optics. That is, the semiconductor lasers 200 are directly coupled to the optical fiber core 210. Throughout this specification, the phrase “directly coupled” refers to coupling with no intervening optical components. The numerical aperture of the fiber with core 210 is typically in the range of about 0.35 to about 0.5, enabling >50% coupling efficiency of edge-emitting semiconductor lasers with direct coupling. FIG. 2 shows typical dimensions of this arrangement, wherein each edge-emitting semiconductor laser has a width around 250 microns and a thickness around 75 microns, enabling 14 such sources to be placed around the perimeter of the 1.15 mm diameter sub-carrier 220. This enables the plurality of radiation components 270 to fit within the 1.5 mm diameter fiber core 210. Typical fiber core diameters for multi-mode sensor applications are in the range of about 50 microns to about 5 millimeters.

FIG. 3 is a view of the section A-A′ indicated in FIG. 2, illustrating how the semiconductor lasers 200 can be connected to a circuit board 260, which in turn is connected to an external power supply through electrical connections 280. The connection between sources 200 and the circuit board 260 requires a 90 degree electrical bend, accomplished by a flex circuit 250, which is well-known to those skilled in the art. The electrical signals traveling along the connections 280 are in a plane substantially perpendicular to an axis 290 of the cylindrical sub-carrier 220. FIG. 3 also shows how an output radiation 300 from the fiber core 210 impinges on a sample 310, generating a diffusely reflected radiation 320 detected by a broadband optical detector 330. The detector 330 is typically a p-i-n detector, but can also be an avalanche photodiode in alternate embodiments. Broadband detectors are well-known to those skilled in the art of optical measurements, and detectors can be comprised of Indium Gallium Arsenide, Silicon or other materials, depending on the application and wavelengths of illumination.

Since the radiation impinging on the sample 310 has a maximum transverse dimension that is not smaller than the diameter of fiber core 210, the sample 310 must have a minimum feature size 315 which is also not smaller than the diameter of the optical fiber core 210. Furthermore, since the maximum transverse dimension 225 of the radiation originating from the lasers 200 is smaller than the diameter of fiber core 210, the transverse dimension 225 must be smaller than the minimum feature size 315. We define the minimum feature size as the smallest feature of interest in the sample 315.

The components of FIGS. 2 and 3 function together as key elements of a compact laser array spectrometer. By electrically switching a power supply external to the circuit board 260, amongst the electrical connections 280 to the lasers 200, only one of the lasers is emitting radiation at any given time, and selecting the laser selects the wavelength. Wavelength sweeping is accomplished by sequentially directing electrical power to each of the lasers 200. Further wavelength tuning can be achieved by temperature control of the sub-mount 220, using a thermo-electric cooler, or by resistive heaters integrated with each laser 200. In an alternate but not preferred embodiment, each of the lasers 200 is operated simultaneously, but modulated at a different frequency. The various components contributing to the spectral reflectance can be demodulated by filtering at each modulation frequency.

The preferred embodiment of this invention uses Fabry-Perot edge-emitting lasers for the lasers 200, because thermal tuning rate of lasing wavelength in such lasers is equal to the thermal tuning rate of the gain peak, which can be in the range of about 0.4 nm/C around 980 nm. This thermal tuning rate is much greater than the thermal tuning rate of grating based lasers such as DFB/DBR lasers, which tune at about 0.08 nm/C around 980 nm, or at a rate proportional to the thermal tuning rate of the material index of refraction. For example, in the 650-1000 nm range, approximately 12 Fabry-Perot semiconductor lasers arranged around the perimeter of a nearly circular cross-section polygon can, in conjunction with thermal tuning, provide complete wavelength coverage of the 650-1000 nm range, as described in co-pending application “Fabry-Perot Semiconductor Tunable Laser (60/758,574). An important application of this wavelength range is in broadband diffuse optical spectroscopy for detection of water, lipids, oxy-hemoglobin, and deoxy-hemoglobin, in the detection, characterization, and therapeutic monitoring of breast cancer. This application is one example of an in-vivo biological measurement, and is discussed in (B. Tromberg, N. Shah, R. Lanning, A. Cerussi, J. Espinoza, T. Pham, L. Svaasand, and J. Butler, “Non-Invasive In Vivo Characterization of Breast Tumors Using Photon Migration Spectroscopy,” Neoplasia, vol. 2, nos. 1-2, January-April 2000, pp. 26-40). This application requires both steady state and frequency domain measurements of diffuse tissue reflectance to enable separation of scattering and absorption losses, and the embodiment of FIGS. 2 and 3 addresses this need. Frequency domain measurements can be accomplished by applying a modulated drive current to each of the lasers 200. The embodiment of FIGS. 2 and 3 could also be used to characterize biological samples ex vivo. For this and many other applications, the spectral width of Fabry-Perot lasers, which is on the order of 1-5 nm, is adequately narrow to enable high sensitivity detection, and the <0.1 nm linewidth of grating-based semiconductor lasers such as DFB/DBR lasers is not required. Other applications may require high wavelength resolution, but not complete wavelength coverage, and the configuration of FIGS. 2 and 3 can be realized with DFB/DBR lasers to address such applications. Both DFB/DBR lasers and Fabry-Perot lasers can be modulated at high speeds, as required for frequency domain measurements of breast tissue. This modulation range is typically in the range of about 100 Mhz to about 3 Ghz.

Although the configuration of FIGS. 2 and 3 employs a circular cross-section cylinder for the sub-carrier 220, it is evident that the cross-section can be a polygon of any shape, such as a square, or a many-sided polygon with 4-16 facets. (Throughout this specification, we assume that the term polygon includes circles.) This is especially true when uniform modal excitation is not critical, as is the case of broadband diffuse optical spectroscopy in the 650-1000 nm range.

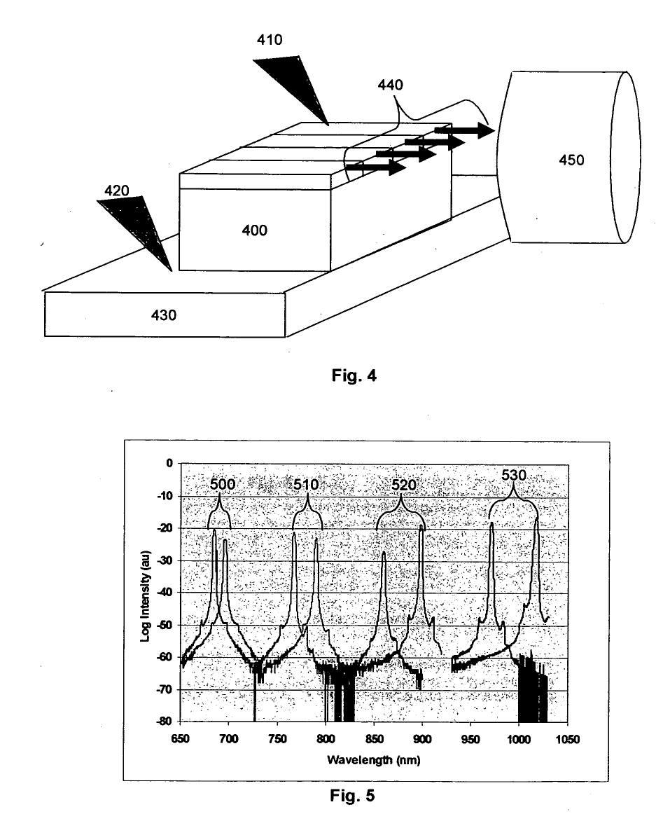

Another preferred embodiment of this invention, when the number of wavelengths is small, is a linear array. For example, in a 4-channel system, a linear array of four edge-emitting lasers with a width of 250 microns each can fit within the 1 mm core of a multi-mode fiber. Linear arrays can also be stacked to make two-dimensional arrays which can be directly coupled to fiber. FIG. 4 shows the preferred linear array embodiment, along with an experimental configuration used to test a prototype 4-channel array. As in the case of the circular array of FIGS. 2 and 3, a maximum transverse dimension of the linear array is not larger than a minimum feature size of a sample. In the experiment of FIG. 4, a four element edge-emitting laser array 400, resting on a temperature controlled stage 430 and having an element to element spacing of 250 microns, was fabricated and tested. A first element of this array employed an AlInGaP quantum well gain region emitting around 680 nm, a second element employed an AlGaAs quantum well gain region emitting around 780 nm, a third element employed a GaAs quantum well gain region emitting around 880 nm, and a fourth element employed an InGaAs quantum well gain region emitting around 980 nm. The array 400 was assembled from four individually processed laser die using a manual pick and place tool. Linear arrays employing a plurality of gain regions could also be assembled monolithically on a wafer scale, using wafer bonding techniques such as that described in (J. Geske, D. Leonard, M. H. MacDougal, B. Barnes, and J. E. Bowers, “CWDM Vertical Cavity Surface-Emitting Laser Array Spanning 140 nm of the C, S, and L Fiber Transmission Bands,” IEEE Photonics Technology Letters, vol. 16, no. 5, May 2004) Current was applied to each element of the array 400 through a positive electrode 410 and a negative electrode 420. The array emitted four radiation components 440 having four wavelength bands into a common multi-mode fiber 450 having a core diameter of 1 mm. The fiber was held in a fixed position as the array elements were probed sequentially, and the spectra from each element of the array were measured during thermal tuning. FIG. 5 illustrates the spectra observed from the four channels at the fiber output. The four elements of the array emit radiation in first, second, third and fourth wavelength bands 500, 510, 520, and 530, respectively, in the 650-1000 nm wavelength range, representing a total wavelength coverage of about 120 nm. FIGS. 4 and 5 represent reduction to practice of the present invention for the specific case of a linear array of four lasers directly coupled to one common multi-mode fiber, in the 650-1000 nm wavelength range. The thermal tuning demonstrated in FIG. 5 with a 4-channel array illustrates the feasibility of achieving complete wavelength coverage over 650-1000 nm using approximately 12 lasers arranged in either a one-dimensional or two-dimensional array.

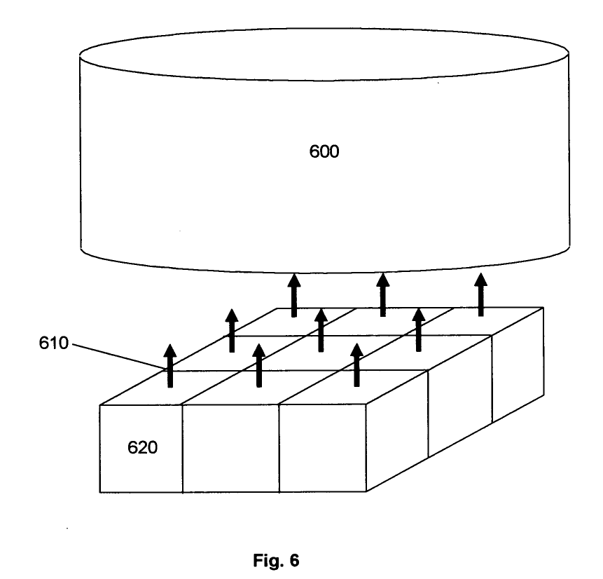

FIG. 6 illustrates another preferred embodiment of the present invention. Here a plurality of vertical cavity surface emitting lasers 620 emits a plurality of radiation components 610 directly into a multi-mode fiber core 600, with no intervening optics. Each of the vertical cavity surface-emitting lasers 600 employs a gain medium of a different composition and emits at a different wavelength. In analogy with FIGS. 2-4, the VCSEL array 620 has a maximum transverse dimension which is small compared to a minimum feature size of a sample being probed. Similarly to FIGS. 2 and 3, electrical switching amongst the plurality of VCSELs 620 enables coverage of a wide range of wavelengths. This is in contrast to the directly coupled VCSEL array described in (S. Y. Hu, J. Ko, E. R. Hegblom, and L. A. Coldren, “Multimode WDM Optical Data Links with Monolithically Integrated Multiple Channel VCSEL and Photo-Detector Arrays,” IEEE J. Quantum Electron. vol. 34, pp. 1403-1414, 1998), where all vertical cavity surface emitting lasers employ the same gain medium material composition, and thus emit over a fairly narrow range of wavelengths.

VCSELs enable easy configuration as two-dimensional arrays, and therefore a large number of VCSELs can be incorporated in the configuration of FIG. 6. However, VCSELs generally provide less output power than edge-emitting lasers, and do not work well at certain critical wavelengths. Also, all VCSELs are DBR lasers whose wavelength tunes as the material refractive index, rather than as the gain peak, so thermal tuning rates are much lower than for Fabry-Perot edge emitting lasers. The configuration of FIG. 6 serves those applications where a large number of discrete selected wavelengths is required, and where lower output power can be tolerated. Of course, further embodiments of this invention could be constructed by combining features of FIGS. 2-6, and employing both VCSELs and edge-emitters in one tunable source.

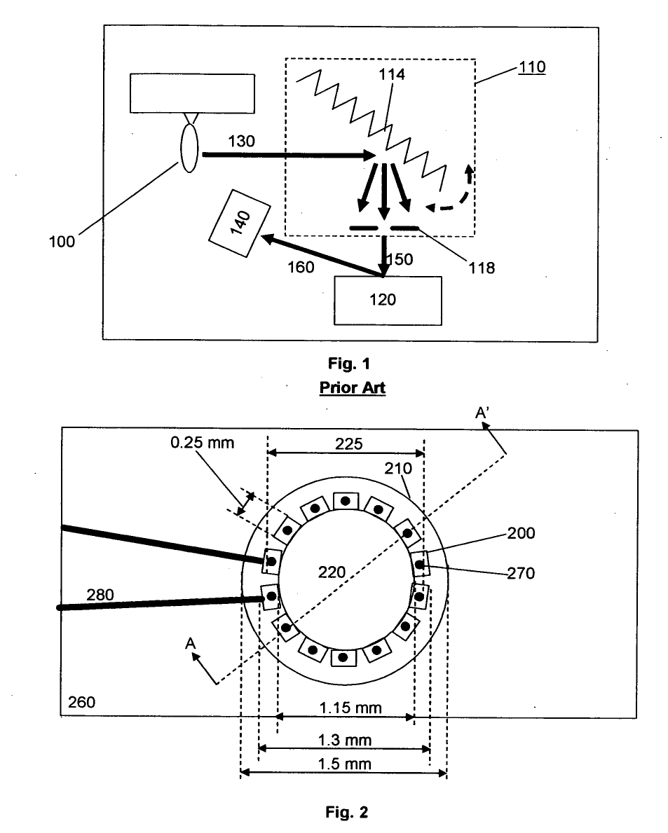

In addition to the 650-1000 nm wavelength range, other ranges and applications of interest for all embodiments of the present invention include the 700-1700 nm range for agricultural applications, and the 1100-2500 nm range for near-infrared spectroscopy. The 700-1700 nm range has proved useful in the spectroscopy of wheat, corn, and insects. See, for example (F. E Dowell, T. C. Pearson, E. B. Maghirang, F. Xie, and D. T. Wicklow, “Reflectance and Transmittance Spectroscopy Applied to Detecting Fumonism in Single Corn Kernels Infected with Fusarium Verticillioides,” Cereal Chemistry vol. 79 (2), pp. 222-226, 2002). The 1100-2500 nm range is extensively used in the characterization of pharmaceutical products, and is a standard wavelength range for near infrared spectroscopy. Both of the above applications rely extensively on prior art grating-based spectrometers such as those of FIG. 1, or variants thereof The present invention promises more compact instrumentation, greater signal to noise ratio, lower power dissipation, and faster measurement times. In addition, the entire wavelength range from about 650 nm to about 2500 nm can be accessed with relatively mature semiconductor laser technology, making the approach feasible. The above application areas are only intended as examples, and are not intended to be limiting. The present invention can be applied wherever spectroscopy provides useful information, using semiconductor lasers of any available wavelength.

While this invention has been particularly shown and described with references to preferred and alternate embodiments thereof, it will be understood by those skilled in the art that various changes in form and details may be made therein without departing from the spirit and scope of the invention as defined by the appended claims.

What is claimed is:

1. A system for spectroscopic characterization of a sample having a minimum feature size, the system comprising
a plurality of semiconductor lasers comprising a plurality of semiconductor gain medium compositions, operative to emit a plurality of radiation components having a plurality of wavelengths and originating from an area having a maximum transverse dimension
wherein said maximum transverse dimension is not greater than said minimum feature size,
a first means for detecting a diffuse reflectance from said sample, and
a second means for directing electrical power to each one of said plurality of semiconductor lasers.

2. The system of claim 1, wherein said second means comprises sequentially powering said plurality of semiconductor lasers, such that only one laser is operative at any point in time.

3. The system of claim 1, wherein said first means includes a detector fabricated from one of the list of materials consisting of Indium Gallium Arsenide, Silicon, and Gallium Arsenide.

4. The system of claim 1, wherein said plurality of semiconductor lasers is disposed on a common sub-carrier.

5. The system of claim 1, further comprising a multimode optical fiber directly coupled to said plurality of radiation components.

6. The system of claim 1, wherein said plurality of semiconductor lasers comprises a plurality of vertical cavity surface emitting lasers.

7. The system of claim 6, wherein said plurality of vertical cavity surface-emitting lasers is configured in a 2-dimensional array.

8. The system of claim 1, wherein said plurality of semiconductor lasers comprises a plurality of edge-emitting semiconductor lasers.

9. The system of claim 8, wherein said plurality of edge-emitting semiconductor lasers comprises a plurality of Fabry-Perot lasers.

10. The system of claim 8, wherein said plurality of edge-emitting semiconductor lasers comprises a plurality of grating-based semiconductor lasers.

11. The system of claim 8, wherein said plurality of edge-emitting semiconductor lasers comprises between about 4 and about 16 edge-emitting semiconductor lasers.

12. The system of claim 1, further comprising means for thermally tuning at least one of said plurality of semiconductor lasers, thereby tuning at least one of said plurality of wavelengths.

13. The system of claim 9, further comprising means for thermally tuning at least one of said plurality of Fabry-Perot lasers, thereby tuning at least one of said plurality of wavelengths.

14. The system of claim 8, wherein said plurality of edge-emitting semiconductor lasers is arranged in a linear array.

15. The system of claim 8, wherein said plurality of edge-emitting semiconductor lasers is arranged in a 2-dimensional array.

16. The system of claim 5, wherein said multi-mode optical fiber has a core diameter in the range between about 50 microns and about 5 millimeters.

17. The system of claim 1, wherein said plurality of wavelengths is in a range between about 650 nm and about 1000 nm.

18. The system of claim 1, wherein said plurality of wavelengths is in a range between about 1100 nm and about 2500 nm.

19. The system of claim 1, wherein said plurality of wavelengths is in a range between about 700 nm and about 1700 nm.

20. The system of claim 1, wherein said plurality of wavelengths encompasses complete wavelength coverage over a range of at least about 200 nm.

21. The system of claim 1, further comprising means for electrically modulating at least one of said plurality of semiconductor lasers at frequencies in a range of about 100 Mhz to about 3 Ghz.

22. The system of claim 8, wherein said plurality of edge-emitting semiconductor lasers is arranged around the perimeter of a cylindrical sub-carrier, wherein a cross-section of said cylindrical sub-carrier is a polygon.

23. The system of claim 22, wherein said polygon has between about 4 and about 16 sides.

24. The system of claim 22, wherein said polygon is a circle.

25. The system of claim 22, further comprising a third means for bending a path of said electrical power into a plane substantially perpendicular to an axis of said cylindrical sub-carrier.

26. The system of claim 25, wherein said third means includes a flex circuit.

27. The system of claim 1, wherein said sample is an in-vivo biological sample.

28. The system of claim 1, wherein said sample is an ex-vivo biological sample.

29. The system of claim 1, wherein said sample is an agricultural sample.

30. The system of claim 1, wherein said sample is a pharmaceutical sample.

31. The system of claim 1, where said sample is in-vivo human breast tissue, and said minimum feature size corresponds to a size of a breast tumor.

32. The system of claim 31, wherein said plurality of wavelengths is in a range of about 650 nm to about 1000 nm.

33. The system of claim 31, wherein said plurality of wavelengths covers substantially all of a range from about 650 nm to about 1000 nm.

34. The system of claim 32, further comprising means for modulating at least one of said plurality of semiconductor lasers at a modulation frequency in a range from about 100 Megahertz to about 3 Gigahertz.
